(19) United States
(12) Patent Application Publication
(10) Pub. No.: US 2024/0215051 A1
(43) Pub. Date: Jun. 27, 2024

(54) METHODS AND SYSTEMS FOR MULTIPLEXING RESOURCES FOR FEEDBACK MESSAGES IN WIRELESS NETWORKS

(71) Applicant: ZTE Corporation, Shenzhen (CN)

(72) Inventors: Xiaolong GUO, Shenzhen (CN); Wei GOU, Shenzhen (CN); Shuaihua KOU, Shenzhen (CN); Xing LIU, Shenzhen (CN); Peng HAO, Shenzhen (CN); Xingguang WEI, Shenzhen (CN)

(21) Appl. No.: 18/532,082

(22) Filed: Dec. 7, 2023

Related U.S. Application Data
(63) Continuation of application No. PCT/CN2021/128901, filed on Nov. 5, 2021.

(51) Int. Cl. H04W 72/30; H04L 1/1812; H04L 5/00

(52) U.S. Cl. CPC H04W 72/30; H04L 1/1812; H04L 5/0055

(57) ABSTRACT

Methods and systems for techniques for multiplexing resources for feedback messages in wireless networks are disclosed. In an implementation, a method of wireless communication includes: configuring, by a network node, a set of channel resources to indicate a plurality of feedback states for different multicast services, wherein each channel resource corresponds to one of the feedback states, wherein each of the feedback states includes a combination of values such that each value indicates whether: a downlink message has been decoded correctly; or the downlink message has not been received or has been decoded incorrectly; and receiving, by the network node, from a wireless device, uplink messages on one of the channel resources corresponding to a feedback state of the wireless device.

### CROSS REFERENCE TO RELATED APPLICATIONS

This patent document is a continuation of and claims benefit of priority to International Patent Application No. PCT/CN2021/128901, filed on Nov. 5, 2021. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for multiplexing resources for feedback messages in wireless networks.

In one aspect, a method of data communication is disclosed. The method includes configuring, by a network node, a set of channel resources to indicate a plurality of feedback states for different multicast services, wherein each channel resource corresponds to one of the feedback states, wherein each of the feedback states includes a combination of values such that each value indicates whether: a downlink message has been decoded correctly; or the downlink message has not been received or has been decoded incorrectly, and receiving, by the network node, from a wireless device, uplink messages on one of the channel resources corresponding to a feedback state of the wireless device.

In another aspect, a method of data communication is disclosed. The method includes performing, by a wireless device, a reception operation to receive and decode a downlink message transmitted from a network node, generating, by the wireless device, a second feedback message that includes a feedback state as to whether: the downlink message has been decoded correctly; or the downlink message has not been received or has been decoded incorrectly, based on a first feedback message that is configured by the network node and includes the feedback state, and transmitting, by the wireless device, the second feedback message to the network node.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows examples of downlink assignment index (DAI) counting performed based on a group radio network temporary identifier (G-RNTI).

FIG. 4 shows an example of a process for wireless communication based on some example embodiments of the disclosed technology.

FIG. 5 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

For unicast communications, only acknowledgement/negative acknowledgement (ACK/NACK) based hybrid automatic repeat request (HARQ)-ACK feedback is utilized, and UE transmits the HARQ-ACK information in UE-specific physical uplink control channel (PUCCH). For multicast communications, ACK/NACK based and NACK-only based HARQ-ACK feedback are supported. ACK/NACK based feedback for multicast is basically the same as ACK/NACK based feedback for unicast. Each UE transmits HARQ-ACK information of the group common physical downlink shared channels (PDSCHs) in UE-specific PUCCH. In order to save PUCCH resources, NACK-only based feedback can be used for the same group common PDSCH, and UEs in the same group transmit the same PUCCH. When the PDSCH is decoded correctly by UE, the corresponding PUCCH will not be transmitted. However, when the PDSCH is not decoded correctly by UE, the network, which knows that the PDSCH is incorrectly decoded when detecting the PUCCH, cannot know which UE transmits the NACK-only PUCCH. ACK/NACK based feedback or NACK-only based feedback is configured per G-RNTI by RRC signaling.

For ACK/NACK based feedback for unicast and multicast communications, PUCCH format 0/1/2/3/4 are all supported to satisfy the requirements for the HARQ-ACK information bits. For NACK-only based feedback, only PUCCH formats 0/1 are supported.

Multicast Broadcast services are scheduled by a group common DCI. All UEs in the group receive the same GC-DCI and the scheduled GC-PDSCH. Each MBS service is corresponding to one G-RNTI, and DAI counting for ACK/NACK based feedback in the GC-DCI is performed per G-RNTI.

For UE that supports both unicast and multicast communications, there can be an overlapping between NACK-only PUCCH and unicast PUCCH/PUSCH/multicast PUCCH for ACK/NACK based feedback, and multiple NACK-only PUCCH transmissions in the same slot can also exist, as the NACK-only feedback mechanism is different from ACK/NACK based feedback, the current multiplexing rules cannot be applied to such a situation. As will be discussed below, the disclosed technology can be implemented in some embodiments to provide techniques for multiplexing resources for feedback messages such as (HARQ)-ACK feedback messages.

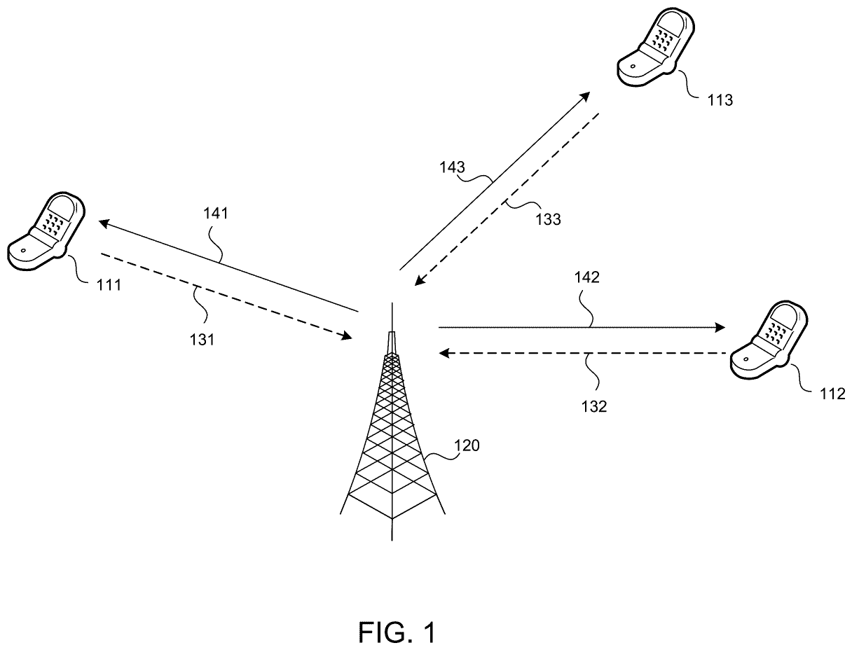

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

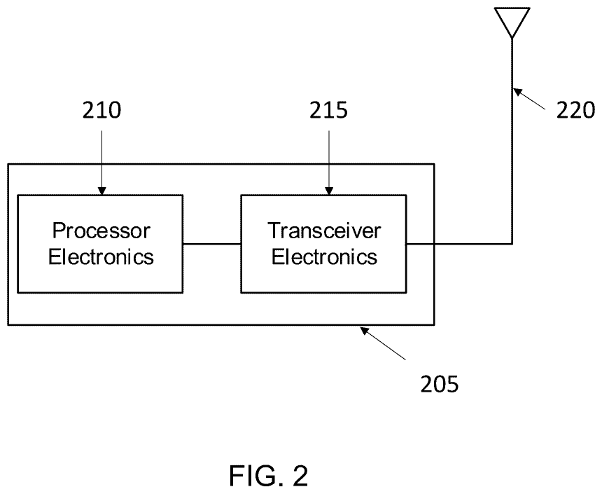

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

### Embodiment 1

The disclosed technology can be implemented in some embodiments to multiplex resources when multiple NACK-only PUCCH transmissions with the same priority are in the same slot, each NACK-only PUCCH is for different MBS services, and no other PUCCH or PUSCH are indicated in the slot. The multiplexing is realized by pre-configuring a set of specific PUCCH resources such that each PUCCH corresponds to one NACK-only feedback state. UE transmits the PUCCH selected from the resources set according to its NACK-only feedback state. The network detects the PUCCH resources in the slot to obtain all possible feedback states.

Assuming that N MBS services are configured to perform NACK-only based HARQ-ACK feedback, each MBS service can only provide one NACK-only PUCCH, so that up to N NACK-only PUCCHs can be indicated in the same slot. In the NACK-only feedback state, N bits are needed, and each bit represents the feedback state of one NACK-only PUCCH. The bits are organized in G-RNTI order of the MBS services, and bit value 1 indicates the PDSCH is correctly decoded, and bit value 0 indicates the PDSCH is incorrectly decoded or the DCI scheduling the PDSCH is not received by UE. In total, up to 2\hat{ }N−1 NACK-only feedback state can be obtained by UEs, and thus, up to 2\hat{ }N−1 PUCCH resources are needed.

As the PUCCH resources are pre-configured by RRC, although not all NACK-only PUCCH for N MBS services are always indicated in the same slot, which indicates not all NACK-only feedback states can be used in each uplink slot, the network always needs to configure the above PUCCH resources. The network can configure the subset of the pre-configured PUCCH resources to each UE according to its MBS services reception situation, and the cardinality of the subset equals 2\hat{ }M−1, M is the number of MBS services reported to receive by UE. Furthermore, the network can recycle PUCCH resources which will not be used when NACK-only PUCCH for some MBS services are not indicated in the slot.

When UE reports to receive one MBS service and NACK-only PUCCH for the corresponding MBS service is not indicated in the slot where NACK-only PUCCHs for other MBS services exist, in order to let gNB know the potential DCI missing case, the bit bundling with the service in NACK-only feedback state should be 0 and it is up to the network to judge whether the bit is valid or not.

Take an example that N equals 3, pre-configured PUCCH resources are listed in Table-1. Assuming UE1 reports to receive all MBS services, the network configures all PUCCH resources to UE1, and UE2 reports to receive MBS #1 and #2. The following analysis is based on the above assumption.

MBS #3 will not be received by UE2, so that only the former 2 bits in the NACK-only feedback state should be valid, and in order not to interrupt feedback of MBS #3 of UE1, the third bit in NACK-only feedback state should always be 1. In other words, it can be regarded that UE2 always provides ACK feedback for MBS #3, so that UE2 is configured with only PUCCH #0/1/3.

For example, gNb actually indicates NACK-only feedback for MBS #1 and #3 in slot n, UE 1 and UE2 will provide the NACK-only feedback state in which the second bit is 0. In other words, UE1 will transmit PUCCH #1/3/5/6 according to the decoding results of MBS #1 and #3, UE2 will transmit PUCCH #1/3 according to the decoding results of MBS #1. Here, the network can recycle the other PUCCH resources to make full use of resources in the slot.

TABLE 1
Pre-configured PUCCH resources for multiplexing
when 3 MBS services are transmitted

| PUCCH | | NACK-only |
|---|---|---|
| index | NACK-only feedback state description | feedback state |
| PUCCH#0 | MBS#1 NACK/not received, MBS#2 ACK, | {0, 1, 1} |
| | MBS#3 ACK | |
| PUCCH#1 | MBS#1 ACK, MBS#2 NACK/not received, | {1, 0, 1} |
| | MBS#3 ACK | |
| PUCCH#2 | MBS#1 ACK, MBS#2 ACK, MBS#3 | {1, 1, 0} |
| | NACK/not received | |
| PUCCH#3 | MBS#1 NACK/not received, MBS#2 | {0, 0, 1} |
| | NACK/not received, MBS#3 ACK | |
| PUCCH#4 | MBS#1 NACK/not received, MBS#2 | {0, 1, 0} |
| | ACK, MBS#3 NACK/not received | |
| PUCCH#5 | MBS#1 ACK, MBS#2 NACK/not received, | {1, 0, 0} |
| | MBS#3 NACK/not received | |
| PUCCH#6 | MBS#1#2#3 all NACK/not received | {0, 0, 0} |

### Embodiment 2

The disclosed technology can be implemented in some embodiments to multiplex resources when multiple NACK-only PUCCH transmissions with the same priority are in the same slot, each NACK-only PUCCH is for different MBS services, and no other PUCCH or PUSCH are indicated in the slot. The multiplexing is realized by transforming or converting NACK-only feedback to ACK/NACK bits. The ACK/NACK bits are transmitted in UE-specific PUCCH resources, which are configured in PUCCH-Config/PUCCH-ConfigurationList for ACK/NACK based feedback.

The disclosed technology can be implemented in some embodiments to apply two methods to obtain transformed ACK/NACK bits as will be discussed below.

Method 1: the disclosed technology can be implemented in some embodiments to utilize the NACK-only feedback states discussed in Embodiment 1 above, directly transmitting the NACK-only feedback states on ACK/NACK based PUCCH in the form of bits. The number of transmitted bits or the codebook size equals the number of MBS services regardless of the number of MBS services transmitted by the network or MBS services reported to receive by UE.

Method 2: the disclosed technology can be implemented in some embodiments to generate ACK/NACK bits for MBS services reported to receive by each UE. If the PDSCH is decoded correctly, the HARQ-ACK bit is set to “1.” If the PDSCH is decode incorrectly or the PDCCH scheduling the PDSCH is not received or the PDSCH is not received, the HARQ-ACK bit is set to “0.” The codebook size equals the number of MBS services reported to receive by UE.

When configured with NACK-only feedback, PRI in the DCI indicates all UEs in the group to transmit NACK-only feedback on the same PUCCH. UE-specific PUCCH resources are needed to transmit transformed ACK/NACK bits, UE determines PUCCH resource from PUCCH-Config/PUCCH-ConfigurationList for ACK/NACK based feedback by the PRI indication in the last DCI among DCIs scheduling MBS services, and these DCIs indicate NACK-only feedback in the same slot.

### Embodiment 3

The disclosed technology can be implemented in some embodiments to multiplex resources when multiple NACK-only PUCCHs collide with unicast PUCCHs/PUSCHs or multicast PUCCHs with the same priority in the same slot, and each NACK-only PUCCH is for different MBS services. The multiplexing is realized by transforming or converting NACK-only feedback to ACK/NACK bits in semi-static manner and transmitting in unicast PUCCH/PUSCH or multicast PUCCH resources.

The disclosed technology can be implemented in some embodiments to apply two methods to obtain transformed ACK/NACK bits as will be discussed below.

Method 1: the disclosed technology can be implemented in some embodiments to generate ACK/NACK bits for MBS services reported to receive by each UE. If the PDSCH is decoded correctly, the HARQ-ACK bit is set to “1.” If the PDSCH is decode incorrectly or the PDCCH scheduling the PDSCH is not received or the PDSCH is not received, the HARQ-ACK bit is set to “0.” The codebook size equals the number of MBS services reported to receive by UE.

Method 2: the disclosed technology can be implemented in some embodiments to generate ACK/NACK bits for MBS services actually transmitted by the network. The number of transmitted bits or the codebook size equals the number of MBS services transmitted by the network. If the PDSCH is decoded correctly, the HARQ-ACK bit is set to “1.” If the PDSCH is decode incorrectly or the PDCCH scheduling the PDSCH is not received or the PDSCH is not received, the HARQ-ACK bit is set to “0.” If UE reports not to receive one MBS service, the corresponding HARQ-ACK bit in the codebook can be either 1 or 0, as the codebook is transmitted on UE-specific PUCCH, the network can recognize that the HARQ-ACK bit is invalid.

The PUCCH resource is determined by the last DCI scheduling unicast PUCCH/PUSCH or multicast PUCCH.

### Embodiment 4

The disclosed technology can be implemented in some embodiments to multiplex resources when multiple NACK-only PUCCHs collide with unicast PUCCHs/PUSCHs or multicast PUCCHs with the same priority in the same slot. The multiplexing is realized by dynamically transforming NACK-only feedback to ACK/NACK bits and transmitting in unicast PUCCH/PUSCH or multicast PUCCH resources.

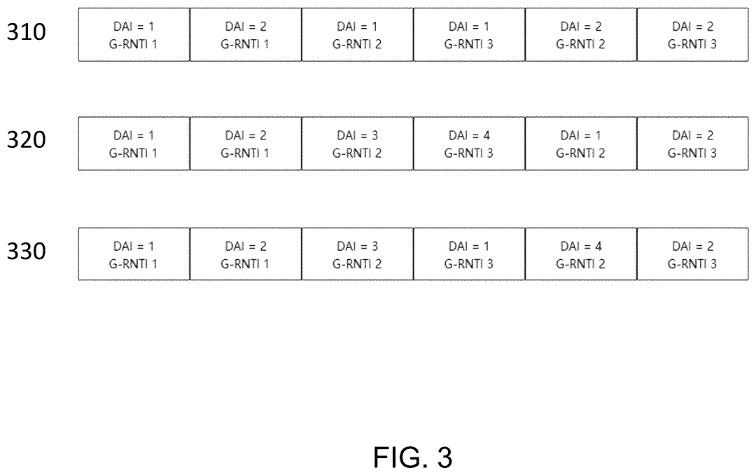

FIG. 3 shows examples of downlink assignment index (DAI) counting performed based on a group radio network temporary identifier (G-RNTI). All cases 310, 320, 330 assume three MBS services (each bundled with one G-RNTI).

Referring to FIG. 3, the first case 310 performs DAI counting per G-RNTI. In this case, 3 DAI counting processes are needed (each for one G-RNTI).

The second case 320 performs DAI counting for all G-RNTIs. In this case, 1 DAI counting process is needed (DAI counting is with the cycle of 4, so that 1 is set after 4).

The third case 330 assumes that G-RNTI 1 and 2 are configured to be one G-RNTI group. Furthermore, G-RNTI 3 is different from the G-RNTI 1 and 2. In this case, 2 DAI counting processes are needed (each for one G-RNTI group).

The disclosed technology can be implemented in some embodiments to apply two methods to obtain transformed ACK/NACK bits as will be discussed below.

Method 1: the disclosed technology can be implemented in some embodiments to perform DAI counting for all G-RNTIs which configured with NACK-only based feedback. The UE generates ACK/NACK bits according to DAI values in the DCIs scheduling MBS services. The network performs DAI counting for all transmitting MBS services, if UE reports not to receive some MBS services, the corresponding DCI will not be received, and the DAI value will be missed, and NACK value will be set for the HARQ-ACK bit. The codebook size equals the number of MBS services transmitted by network, which indicates the codebook sizes of all UEs are the same.

Method 2: the disclosed technology can be implemented in some embodiments to perform DAI counting per G-RNTI group. The network configures each G-RNTI group to contain one or more G-RNTI according to MBS services subscription situation in the group. The UE generates ACK/NACK bits per G-RNTI group separately and concatenates them into one codebook. The codebook size is related to the G-RNTI groups received by each UE. Method 2 can reduce a redundant codebook, unlike method 1.

The PUCCH resource is determined by the last DCI scheduling unicast PUCCH/PUSCH or multicast PUCCH.

### Embodiment 5

The disclosed technology can be implemented in some embodiments to set the rules of HARQ-ACK bits generation ordering when multiple NACK-only PUCCHs need to be multiplexed by transforming to ACK/NACK bits as discussed in Embodiments 2, 3, 4. However, the example implementations discussed in Embodiment 5 are not limited to the above embodiments. In some implementations, the following rules can be applied.

### G-RNTI Ascending Ordering

The HARQ-ACK bits of PDSCHs, which indicate NACK-only feedback in the same uplink slot, are generated in G-RNTI ascending ordering. This rule can be applied to the cases where only one NACK-only PUCCH of one MBS service is indicated in one slot.

### PDSCH Reception Time/Frequency Domain Ordering

The HARQ-ACK bits of PDSCHs, which indicate NACK-only feedback in the same uplink slot, are generated: (1) first, in PDSCH reception time ascending ordering; and (2) second, when the starting reception times for some PDSCHs are the same, then in PDSCH reception frequency domain ascending ordering.

### Combination of Rules

When collision happens applying one of the above rules, the combination of the rules discussed above can work together to address the collision.

### DAI Counting Rules

The HARQ-ACK bits of PDSCHs, which indicate NACK-only feedback in the same uplink slot, are generated based on the DAI field in the group common DCI scheduling corresponding to PDSCHs. DAI counting can be performed per G-RNTI, per G-RNTI group or all G-RNTIs.

### Embodiment 6

The disclosed technology can be implemented in some embodiments to multiplex resources when multiple NACK-only PUCCHs collide with unicast/multicast HARQ-ACK PUCCH or CSI PUCCH with the same priority in the same slot. The multiplexing is realized by transforming or converting NACK-only feedback to ACK/NACK feedback and generating joint HARQ-ACK codebook as what defined for ACK/NACK based HARQ-ACK feedback for multicast communications.

When NACK-only feedback and ACK/NACK based feedback are both configured for multicast communications, if multiplexing is needed, NACK-only feedback will be transformed to ACK/NACK feedback, and it can be regarded that all MBS services are configured with ACK/NACK based feedback. HARQ-ACK codebook generation and PUCCH determination are based on the rules for ACK/NACK based feedback for multicast communications.

If NACK-only feedback is to be transformed to ACK/NACK feedback due to a collision with unicast/multicast HARQ-ACK PUCCH, the codebook type for transformed ACK/NACK bits follows what is configured for unicast/multicast HARQ-ACK feedback. If the codebook type for unicast HARQ-ACK feedback is configured to be the enhanced Type-2 or Type-3, Type-1 or Type-2 codebook will be applied by default. The PUCCH resource for transmitting all HARQ-ACK information is determined by the last DCI corresponding to the unicast/multicast HARQ-ACK PUCCH.

If NACK-only feedback is to be transformed to ACK/NACK feedback due to a collision with unicast/multicast CSI PUCCH, Type-1 or Type-2 codebook will be applied by default when the codebook type is not configured for unicast/multicast feedback. The PUCCH resource for transmitting all HARQ-ACK and CSI information is determined by the last DCI corresponding to the NACK-only PUCCH or is additionally configured by the network.

If NACK-only feedback is transformed to provide HARQ-ACK information as Type-1 codebook, TDM-ed or FDM-ed Type-1 codebook construction can be reused when both unicast and multicast are supported.

If NACK-only feedback is transformed to provide HARQ-ACK information as Type-2 codebook, as defined for multicast ACK/ANCK feedback, Type-2 sub-codebooks are generated per G-RNTI and concatenate all sub-codebooks into one.

### Embodiment 7

The disclosed technology can be implemented in some embodiments to multiplex resources when one NACK-only PUCCH overlaps with unicast/multicast PUCCH format 0/1 carrying 2 bits HARQ-ACK information in the same slot, and they are with the same priority. The multiplexing is realized by generating 3 bits HARQ-ACK information and transmitting them on one new PUCCH format 2/3/4

The bit transformed or converted from NACK-only feedback is concatenated after 2 bits HARQ-ACK information, as both PUCCHs in the case are format 0/1, they cannot carry more than 2 bits of HARQ-ACK information. UE determines one new PUCCH format 2/3/4 by PRI indication in the last DCI, which corresponds to the unicast/multicast PUCCH carrying 2 bits of HARQ-ACK information.

As discussed above, the disclosed technology can be implemented in some embodiments to multiplex resources when NACK-only PUCCH(s) need to multiplex with other PUCCH/PUSCH with the same priority.

In some embodiments of the disclosed technology, when multiple NACK-only PUCCH transmissions with the same priority are in the same slot, each NACK-only PUCCH is for different MBS services, and no other PUCCH or PUSCH are indicated in the slot, the multiplexing is realized by pre-configuring a set of specific PUCCH resources. Each PUCCH corresponds to one NACK-only feedback state, and UE transmits the PUCCH selected from the resources set according to its NACK-only feedback state. The network detects the PUCCH resources in the slot to obtain all possible feedback states.

In some embodiments of the disclosed technology, when multiple NACK-only PUCCH transmissions with the same priority are in the same slot, each NACK-only PUCCH is for different MBS services, and no other PUCCH or PUSCH are indicated in the slot, the multiplexing is realized by transforming NACK-only feedback to ACK/NACK bits. The ACK/NACK bits are transmitted in UE-specific PUCCH resources, which are configured in PUCCH-Config/PUCCH-ConfigurationList for ACK/NACK based feedback.

In an implementation, the NACK-only feedback state is utilized to directly transmit them on ACK/NACK based PUCCH in the form of bits.

In another implementation, ACK/NACK bits are generated according to NACK-only feedback state of each received PDSCHs.

In some embodiments of the disclosed technology, when multiple NACK-only PUCCHs collide with unicast PUCCH/PUSCH or multicast PUCCH with the same priority in the same slot, the multiplexing is realized by transforming NACK-only feedback to ACK/NACK bits in a semi-static manner and transmitting is performed in unicast PUCCH/PUSCH or multicast PUCCH resources.

In an implementation, ACK/NACK bits are generated for MBS services reported to receive by each UE.

In another implementation, ACK/NACK bits are generated for MBS services actually transmitted by network, the number of transmitted bits or the codebook size equals the number of MBS services transmitted by network.

In some embodiments of the disclosed technology, when multiple NACK-only PUCCHs collide with unicast PUCCH/PUSCH or multicast PUCCH with the same priority in the same slot, the multiplexing is realized by transforming NACK-only feedback to ACK/NACK bits in a dynamic manner and transmitting is performed in unicast PUCCH/PUSCH or multicast PUCCH resources.

In an implementation, DAI counting is performed for all G-RNTIs, which is configured with NACK-only based feedback, and UE generates ACK/NACK bits according to DAI values in the DCIs scheduling MBS services.

In another implementation, DAI counting is performed per G-RNTI group, and the network configures each G-RNTI group to contain one or more G-RNTI according to MBS services subscription situation in the group. UE generates ACK/NACK bits per G-RNTI group separately and concatenates them into one codebook.

In some embodiments of the disclosed technology, when multiple NACK-only PUCCHs need to be multiplexed by transforming to ACK/NACK bits, HARQ-ACK bits generation ordering can be determined based on: G-RNTI ascending ordering; PDSCH reception time/frequency domain ordering; DAI counting rules; and combination rules, as discussed above.

In some embodiments of the disclosed technology, when multiple NACK-only PUCCHs collide with multicast HARQ-ACK PUCCH with the same priority in the same slot, the multiplexing is realized by transforming NACK-only feedback to ACK/NACK feedback and generating a joint HARQ-ACK codebook as what is defined for ACK/NACK based HARQ-ACK feedback for multicast. It can be regarded that all MBS services are configured with ACK/NACK based feedback.

In some embodiments of the disclosed technology, when one NACK-only PUCCH overlaps with unicast/multicast PUCCH format 0/1 carrying 2 bits HARQ-ACK information in the same slot and with the same priority, the multiplexing is realized by generating 3 bits HARQ-ACK information and transmitting them on one new PUCCH format 2/3/4.

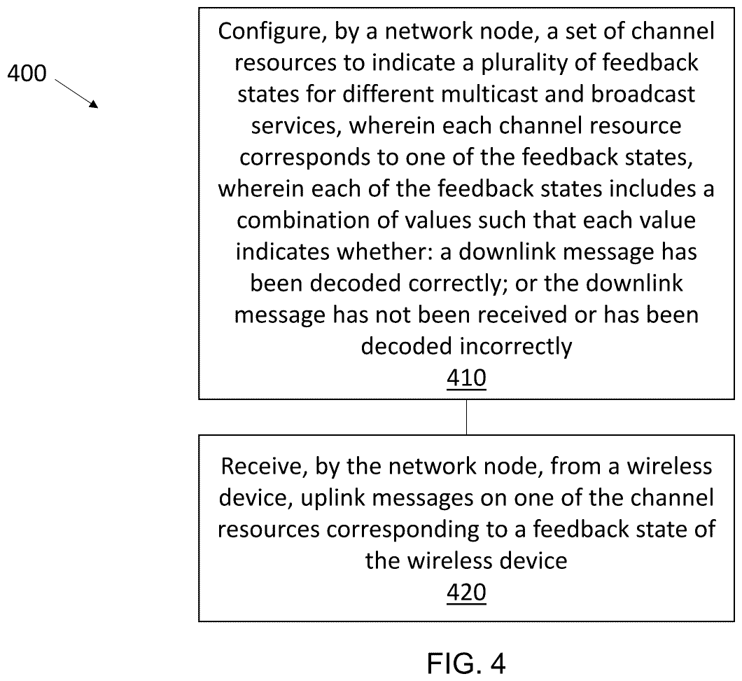

FIG. 4 shows an example of a process for wireless communication based on some example embodiments of the disclosed technology.

In some implementations, the process 400 for wireless communication may include, at 410, configuring, by a network node, a set of channel resources to indicate a plurality of feedback states for different multicast services, wherein each channel resource corresponds to one of the feedback states, wherein each of the feedback states includes a combination of values such that each value indicates whether: a downlink message has been decoded correctly; or the downlink message has not been received or has been decoded incorrectly, and at 420, receiving, by the network node, from a wireless device, uplink messages on one of the channel resources corresponding to a feedback state of the wireless device.

In some implementations, the downlink messages are transmitted on a physical downlink shared channel (PDSCH), and the uplink messages are transmitted on a physical uplink control channel (PUCCH).

In some implementations, the feedback states include negative acknowledgement only (NACK-only) hybrid automatic repeat request (HARQ) feedback states.

In some implementations, the multicast services include the MBS discussed above.

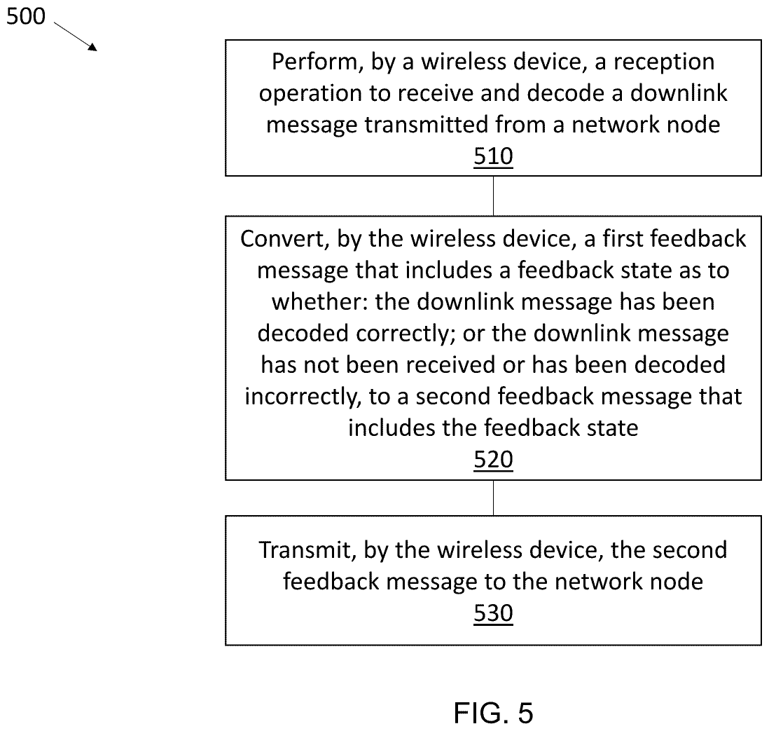

FIG. 5 shows another example of a process for wireless communication based on some example embodiments of the disclosed technology.

In some implementations, the process 500 for wireless communication may include, at 510, performing, by a wireless device, a reception operation to receive and decode a downlink message transmitted from a network node, at 520, generating, by the wireless device, a second feedback message that includes a feedback state as to whether: the downlink message has been decoded correctly; or the downlink message has not been received or has been decoded incorrectly, based on a first feedback message that is configured by the network node and includes the feedback state, and, at 530, transmitting, by the wireless device, the second feedback message to the network node.

In some implementations, the downlink messages are transmitted on a physical downlink shared channel (PDSCH), and the uplink messages are transmitted on a physical uplink control channel (PUCCH).

In some implementations, the first feedback message includes NACK-only feedback message, and the second feedback message includes ACK/NACK feedback message.

In some implementations, the generating of the second feedback message may include transforming or converting NACK-only feedback to ACK/NACK bits, as discussed above.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A wireless communication method, comprising: configuring, by a network node, a set of channel resources to indicate a plurality of feedback states for different multicast services, wherein each channel resource corresponds to one of the feedback states, wherein each of the feedback states includes a combination of values such that each value indicates whether: a downlink message has been decoded correctly; or the downlink message has not been received or has been decoded incorrectly; and receiving, by the network node, from a wireless device, uplink messages on one of the channel resources corresponding to a feedback state of the wireless device.

Clause 2. The method of clause 1, wherein the downlink messages are transmitted on a physical downlink shared channel (PDSCH), and the uplink messages are transmitted on a physical uplink control channel (PUCCH).

Clause 3. The method of clause 1, wherein the feedback states include ACK or NACK values of hybrid automatic repeat request (HARQ) feedback states.

Clause 4. A wireless communication method, comprising: performing, by a wireless device, a reception operation to receive and decode a downlink message transmitted from a network node; generating, by the wireless device, a second feedback message that includes a feedback state as to whether: the downlink message has been decoded correctly; or the downlink message has not been received or has been decoded incorrectly, based on a first feedback message that is configured by the network node and includes the feedback state; and transmitting, by the wireless device, the second feedback message to the network node.

Clause 5. The method of clause 4, wherein the second feedback message is transmitted, from the wireless device to the network node, on a channel resource configured to carry the second feedback message.

Clause 6. The method of clause 5, wherein the channel resource is determined based on downlink control information (DCI) configured to schedule a transmission of the first feedback message.

Clause 7. The method of clause 5, wherein the channel resource includes at least one of a unicast physical uplink control channel (PUCCH) or physical uplink shared channel (PUSCH).

Clause 8. The method of clause 4, wherein the feedback state includes a combination of values such that each value indicates whether: the downlink message has been decoded correctly; or the downlink message has not been received or has been decoded incorrectly.

Clause 9. The method of any of clauses 4-8, wherein a codebook size for the feedback messages is same as a total number of multicast services.

Clause 10. The method of any of clauses 4-8, wherein a codebook size for the feedback messages is same as a number of multicast services to be received by the wireless device.

Clause 11. The method of clause 4, wherein the generating of the second feedback message includes performing a downlink assignment index (DAI) counting for all group radio network temporary identifiers.

Clause 12. The method of clause 4, wherein the generating of the second feedback message includes performing a downlink assignment index (DAI) counting per G-RNTI set configured in the network node.

Clause 13. The method of any of clauses 4-12, wherein information bits of the second feedback message are generated in G-RNTI ascending order.

Clause 14. The method of any of clauses 4-14, wherein information bits of the second feedback message are generated in order of receipt of physical downlink shared channel (PDSCH).

Clause 15. The method of any of clauses 4-14, wherein information bits of the second feedback message are generated in G-RNTI ascending order, or in order of receipt of PDSCH, or in G-RNTI ascending order and order of receipt of PDSCH, or based on a DAI field in a group common downlink control information (DCI).

Clause 16. The method of clause 15, wherein a counting on the DAI field is performed for all G-RNTIs.

Clause 17. The method of clause 15, wherein a counting on the DAI field is performed per G-RNTI set.

Clause 18. The method of any of clauses 4-17, wherein the first feedback message is an NACK-only PUCCH feedback message and the second feedback message is an acknowledgement and negative acknowledgement (ACK/NACK) feedback message.

Clause 19. An apparatus for wireless communication, comprising a memory and a processor, wherein the processor reads code from the memory and implements a method recited in any of clauses 1 to 18.

Clause 20. A computer readable program storage medium having code stored thereon, the code, when executed by a processor, causing the processor to implement a method recited in any of clauses 1 to 18.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
configuring, by a network node, a set of channel resources to indicate a plurality of feedback states for different multicast services, wherein each channel resource corresponds to one of the feedback states, wherein each of the feedback states includes a combination of values such that each value indicates whether: a downlink message has been decoded correctly; or the downlink message has not been received or has been decoded incorrectly; and
receiving, by the network node, from a wireless device, uplink messages on one of the channel resources corresponding to a feedback state of the wireless device.

2. The method of claim 1, wherein the downlink messages are transmitted on a physical downlink shared channel (PDSCH), and the uplink messages are transmitted on a physical uplink control channel (PUCCH).

3. The method of claim 1, wherein the feedback states include ACK or NACK values of hybrid automatic repeat request (HARQ) feedback states.

4. A wireless communication method, comprising:
performing, by a wireless device, a reception operation to receive and decode a downlink message transmitted from a network node;
generating, by the wireless device, a second feedback message that includes a feedback state as to whether: the downlink message has been decoded correctly; or the downlink message has not been received or has been decoded incorrectly, based on a first feedback message that is configured by the network node and includes the feedback state; and
transmitting, by the wireless device, the second feedback message to the network node.

5. The method of claim 4, wherein the second feedback message is transmitted, from the wireless device to the network node, on a channel resource configured to carry the second feedback message.

6. The method of claim 5, wherein the channel resource is determined based on downlink control information (DCI) configured to schedule a transmission of the first feedback message.

7. The method of claim 5, wherein the channel resource includes at least one of a unicast physical uplink control channel (PUCCH) or physical uplink shared channel (PUSCH).

8. The method of claim 4, wherein the feedback state includes a combination of values such that each value indicates whether: the downlink message has been decoded correctly; or the downlink message has not been received or has been decoded incorrectly.

9. The method of claim 4, wherein a codebook size for the feedback messages is same as a total number of multicast services.

10. The method of claim 4, wherein a codebook size for the feedback messages is same as a number of multicast services to be received by the wireless device.

11. The method of claim 4, wherein the generating of the second feedback message includes performing a downlink assignment index (DAI) counting for all group radio network temporary identifiers.

12. The method of claim 4, wherein the generating of the second feedback message includes performing a downlink assignment index (DAI) counting per G-RNTI set configured in the network node.

13. The method of claim 4, wherein information bits of the second feedback message are generated in G-RNTI ascending order.

14. The method of claim 4, wherein information bits of the second feedback message are generated in order of receipt of physical downlink shared channel (PDSCH).

15. The method of claim 4, wherein information bits of the second feedback message are generated in G-RNTI ascending order, or in order of receipt of PDSCH, or in G-RNTI ascending order and order of receipt of PDSCH, or based on a DAI field in a group common downlink control information (DCI).

16. The method of claim 15, wherein a counting on the DAI field is performed for all G-RNTIs.

17. The method of claim 15, wherein a counting on the DAI field is performed per G-RNTI set.

18. The method of claim 4, wherein the first feedback message is an NACK-only PUCCH feedback message and the second feedback message is an acknowledgement and negative acknowledgement (ACK/NACK) feedback message.

19. An apparatus for wireless communication, comprising a memory and a processor, wherein the processor reads code from the memory and implements a method, comprising:
performing a reception operation to receive and decode a downlink message transmitted from a network node;
generating a second feedback message that includes a feedback state as to whether: the downlink message has been decoded correctly; or the downlink message has not been received or has been decoded incorrectly, based on a first feedback message that is configured by the network node and includes the feedback state; and
transmitting the second feedback message to the network node.

20. (canceled)

21. The apparatus of claim 19, wherein the first feedback message is an NACK-only PUCCH feedback message and the second feedback message is an acknowledgement and negative acknowledgement (ACK/NACK) feedback message.
